(19) United States
(12) Patent Application Publication
(10) Pub. No.: US 2010/0068504 A1
(43) Pub. Date: Mar. 18, 2010

(54) MULTIPLE-COATING PARTICLE AND ANTI-GLARE FILM HAVING THE SAME

(76) Inventors: Shih-Pin Lin, Taipei City (TW); Chang-Jian Weng, Chiayi City (TW); Chin-Sung Chen, Jhongli City (TW); Ming-Huei Chen, Pingzhen City (TW)

Correspondence Address: Muncy, Geissler, Olds & Lowe, PLLC, P.O. BOX 1364, FAIRFAX, VA, 22038-1364, US

(21) Appl. No.: 12/558,292

(22) Filed: Sep. 11, 2009

(30) Foreign Application Priority Data
Sep. 12, 2008 (TW) 097135228

(51) Int. Cl. B32B 5/16; B32B 38/00; C08L 25/06; C08L 33/10; C09D 7/12

(52) U.S. Cl. 428/327; 156/60; 525/241; 525/222; 524/101; 524/442; 106/316

(57) ABSTRACT

The present invention relates to a multiple-coating particle and an anti-glare film having the same. The anti-glare film includes a transparent resin and a plurality of multiple-coating particles. The multiple-coating particles are evenly distributed in the transparent resin. The multiple-coating particle is composed of at least two layers of the distinct transparent materials so as to scatter and refract light due to different refractive indexes and to provide anti-glaring effect.

This application claims the priority based on a Taiwanese Patent Application No. 097135228, filed on Sep. 12, 2008, the disclosure of which is incorporated herein by reference in its entirety.

### BACKGROUND OF THE INVENTION

1. Field of the Invention

The present invention generally relates to an anti-glare film with multiple-coating particles. Particularly, the present invention relates to multiple-coating particles capable of scattering and refracting incident light and an anti-glare film with the multiple-coating particles.

2. Description of the Prior Art

In modern society, display devices have become a necessary commodity in our daily life. Such display devices are applied to a lot of electronics such as display devices of mobile phones, television screens, computer monitors, and various display panels. For alleviating the burden of user's eyes, a preferred display is usually coated with an optical film capable of preventing from the glaring to hurt user's eyes (such a film is also called anti-glare film). In general, technicians will add certain light refracting particles (usually, inorganic oxide particles) to achieve anti-glaring effect. However, if the refractive index of such particles is too high, the whole optical film will be too hazy to being seen.

As described in Taiwanese Patent No. M252022, if a UV curable transparent acrylic resin is added with more than one type of four mixed particles which are inorganic metal oxide particles coated with acrylic monomer or silanol coupling agent, such particles are capable of eliminating scattering light to achieve anti-glaring effect.

Moreover, with reference to Taiwanese Patent No. M298514, a plurality of the first transparent particles and the second transparent particles are mixed in a transparent resin layer. The surface of the first transparent particles comprises acrylic functional group. The first transparent particles are uniformly distributed in the transparent resin layer so as to decrease the refractive index of the transparent resin layer and to achieve anti-glaring effect. The diameter of the second transparent particle is larger than the diameter of the first transparent particle. Certain second transparent particles are distributed in the transparent resin layer, and other second transparent particles are exposed at the surface of the transparent resin to make the resin surface rough so as to achieve anti-glaring effect.

Although the above-mentioned technique can solve the glaring problem, the optical film formed by such technique will be so thick that the backlight module has to increase luminant efficiency in order to maintain its luminosity. Therefore, it is desired to provide an anti-glare film to overcome the above problem

### SUMMARY OF THE INVENTION

It is an object of the present invention to provide multiple-coating particles for an anti-glare film which can reduce manufacture cost by reducing required material, while maintaining similar functions.

It is another object of the present invention to provide an anti-glare film, which is made of a transparent resin with multiple-coating particles, and the refractive indexes between the transparent resin and the particles are different in order to achieve anti-glaring effect.

It is a further object of the present invention to provide an anti-glare film having multiple-coating particles to improve the light transmission ratio of the anti-glare film.

A multiple-coating particle for the anti-glare film includes a core particle and an outer layer. The core particle is made of a first organic compound; and the outer layer is made of a second organic compound. The outer layer is coated on the core particle to form the multiple-coating particle. The diameter of the multiple-coating particle is between 50 nm and 10 μm. The refractive index of the multiple-coating particle is between 1.45 and 1.62. The first organic compound is selected from the group consisting of polystyrene, polymethylmethacrylate (PMMA), melamine, silicon oxide, and a combination thereof. The second organic compound is selected from the group consisting of polystyrene, polymethylmethacrylate (PMMA), melamine, silicon oxide, and a combination thereof.

Silicon oxide of the first organic compound and the second organic compound includes a structure: R¹ₙSi(OR²)₄₋ₙ. R¹ group is an alkyl group and can be the same with or different from R² group. R¹ group and R² group are among C₁˜C₁₂ alkyl group, respectively, and wherein n can be 1 or 2. The refractive index difference between the second organic compound and the first organic compound is between 0.05 and 0.17. In otherwords, the refractive index difference between the core particle and the outer layer is between 0.05 and 0.17.

The anti-glare film of the present invention includes the above identified multiple-coating particles and a transparent resin. The multiple-coating particles are distributed in the transparent resin. The multiple-coating particles may be uniformly distributed in the transparent resin to obtain preferred anti-glaring effect. The refractive index difference between the multiple-coating particles and the transparent resin is between 0.01 and 0.15 so as to achieve anti-glaring effect. Moreover, the weight percentage of the multiple-coating particles in the transparent resin is between 1% and 15%. The transparent resin in the present invention can be cured by an effect selected from the group consisting of ultraviolet ray, infrared ray, visible light, thermo effect, pressure, radiation, or a combination thereof.

### BRIEF DESCRIPTION OF THE DRAWINGS

FIG. 1A shows a side view of a multiple-coating particle;

FIG. 1B shows a side view of another embodiment of a multiple-coating particle;

FIG. 1C shows a schematic view showing the anti glaring effect of the present invention;

FIG. 2A shows a schematic view of an embodiment of an anti-glare film;

FIG. 2B shows a schematic view of another embodiment of an anti-glare film;

FIG. 3A shows a schematic view of an embodiment of an anti-glare film;

FIG. 3B shows a schematic view of another embodiment of an anti-glare film;

FIG. 4A shows a schematic view of an embodiment of an anti-glare film on a substrate;

FIG. 4B shows a schematic view of another embodiment of an anti-glare film on a substrate; and

FIG. 5 shows a process figure of manufacturing an anti-glare film in the present invention.

### DETAILED DESCRIPTION OF THE PREFERRED EMBODIMENT

The present invention provides a multiple-coating particle and an anti-glare film comprising a plurality of the multiple-coating particles for providing anti-glaring effect. The anti-glare film can prevent viewers' eyes from being hurt in a high luminant environment (e.g. under sunlight). In an embodiment, the anti-glare film of the present invention can adhere or be attached to a liquid crystal display (LCD). However, in another embodiment, the anti-glare film of the present invention can adhere or be attached to an organic light emitting diode display panel or polymer light emitting diode (PLED) display panel. Particularly, the anti-glare film of the present invention can be applied to a variety of display panels, including flat screens of home televisions, personal computers, and laptops, monitors of mobile phones, and digital cameras, etc.

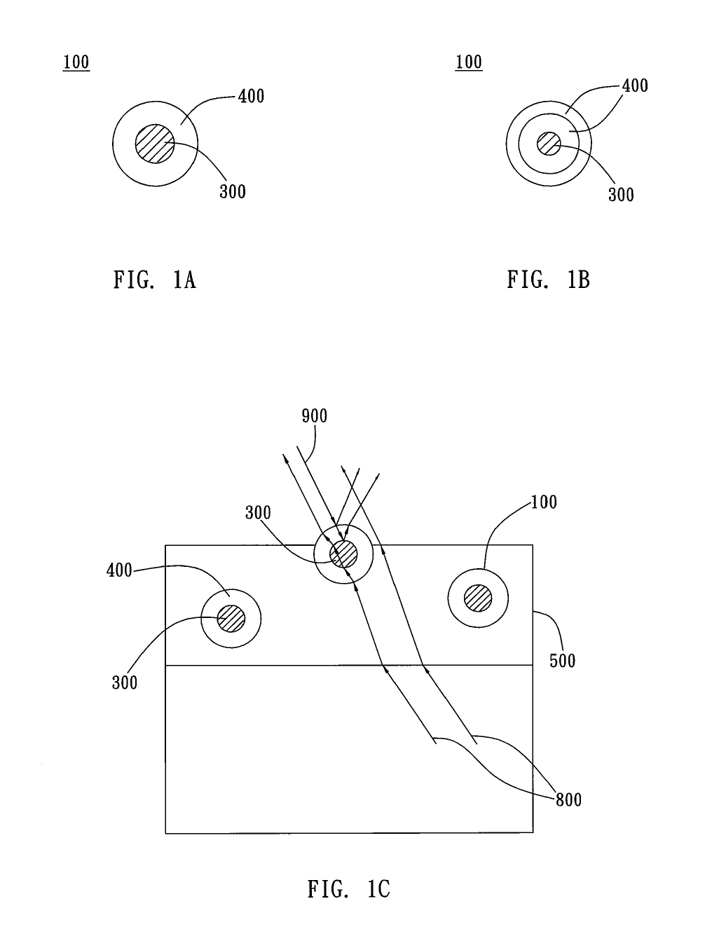

With reference to FIG. 1A, a multiple-coating particle 100 of the present invention includes a core particle 300 and at least an outer layer 400. The core particle 300 is made of a first organic compound and the outer layer 400 is made of a second organic compound. In other words, the core particle 300 is coated with the second organic compound to form the multiple-coating particle 100. In an embodiment shown in FIG. 1A, the multiple-coating particle 100 is a two-layer organic particle made of the core particle 300 and the outer layer 400. In the present invention, the multiple-coating particle 100 is also called a capsular particle. Thus, the multiple-coating particle 100 includes the capsular particle. However, in another embodiment shown in FIG. 1B, the multiple-coating particle 100 is not limited to only a two-layer particle. In this case, the multiple-coating particle 100 can be made of two layers of the outer layers. Since materials of the core particle 300 and the outer layer 400 are different, the present invention can use fewer multiple-coating particles to achieve similar anti-glaring and anti-reflecting effect. Consequently, the manufacture cost is significantly reduced due to the use of multiple-coating particles.

With reference to FIG. 1A, the diameter of the multiple-coating particle 100 is between 10 nm and 50 μm, preferably, between 50 nm and 10 μm. The refractive index of the multiple-coating particle 100 is between 1.0 and 1.8, preferably, between 1.45 and 1.62. In an embodiment, a branch of the first organic compound includes at least a double bond; nevertheless, in another embodiment, the branch of the first organic compound is not limited to including only one double bond. In an embodiment, the first organic compound is preferably made of a compound including at least one double bond, such as polystyrene, polymethylmethacrylate (PMMA), melamine, silicon oxide, or a combination thereof. The second organic compound can be made of silicon oxide, polystyrene, polymethylmethacrylate (PMMA), melamine, or a combination thereof. Please note that the organic materials of the core particle 300 and the outer layer 400 in the multiple-coating particle 100 are different.

The structure of silicon oxide in the first organic compound and the second organic compound is R¹ₙSi(OR²)₄₋ₙ. R¹ group is an alkyl group and can be the same with or different from R² group. R¹ group and R² group are among C₁˜C₁₂ alkyl group, respectively, and wherein n can be 1 or 2. All silicon oxides satisfying the above-identified structure are included in the present invention. For achieving anti-glaring effect, the refractive index difference between the core particle 300 of the first organic compound, and the outer layer 400 of the second organic compound, is between 0.01 and 0.3, and preferably, between 0.05 and 0.17.

With reference to FIG. 1C, emitting light 800 is refracted at certain angles due to the refractive index difference of different media. When emitting light 800 enters the multiple-coating particle 100, emitting light 800 is refracted due to the refractive index difference between the core particle 300 and the outer layer 400, and the refractive index difference between the multiple-coating particle 100 and the transparent resin 500. Similar phenomena will also occur when incident light 900 enters. By the different materials used for the core particle 300 and the outer layer 400 of the multiple-coating particle 100, the reflected incident light 900 from the core particle 300 will be refracted at the interface between the outer layer 400 and air. Consequently, when a lot of incident light 900 enters, the present invention can refract the reflected light so as to achieve anti-glaring effect.

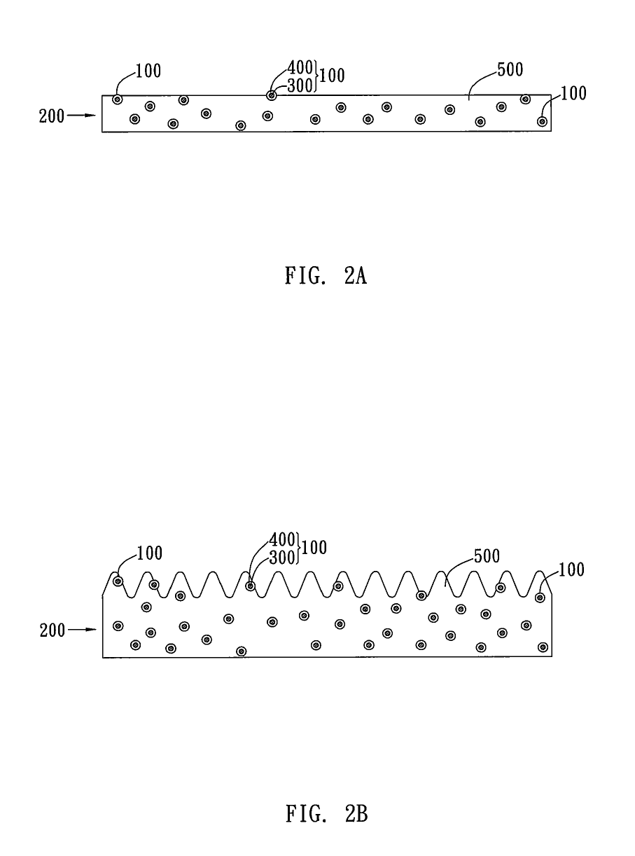

In the embodiment shown in FIG. 2A, the anti-glare film 200 of the present invention includes the above-mentioned multiple-coating particles 100 and the transparent resin 500. In order to prevent users from being hurt or suffering from glaring when they watch the display, the refractive index difference between the multiple-coating particle 100 and the transparent resin 500 in the anti-glare film 200 is between 0.001 and 0.5, preferably between 0.01 and 0.15. The numbers of the multiple-coating particles 100 in the anti-glare film 200 is fewer than the numbers of traditional transparent particles in conventional anti-glare films. The weight ratio of the multiple-coating particles 100 to the transparent resin 500 is between 0.1% and 20%, and preferably, between 1% and 15%. Since the transparency of an anti-glare film decreases as the particles therein increases, the anti-glare film 200 of the present invention has the advantage of using fewer particles and thus having less reduction in transparency. Some of the multiple-coating particles 100 may protrude out of the surface of the transparent resin 500.

In an embodiment, the transparent resin 500 can be cured by an effect selected from the group consisting of ultraviolet ray, infrared ray, visible light, thermo effect, pressure, radiation, or a combination thereof. The material of the transparent resin 500 is selected from the group consisting of polyester resin, polyether resin, acrylic acid resin, epoxy resin, urethane resin, alkyd resin, spiro acetal resin, polythiol polyolefin resin, polybutadiene resin, and a combination thereof.

In another embodiment shown in FIG. 2B, the surface of the transparent resin 500 is formed as a convex-concave structure. Certain multiple-coating particles 100 may protrude out of such surface of the transparent resin 500.

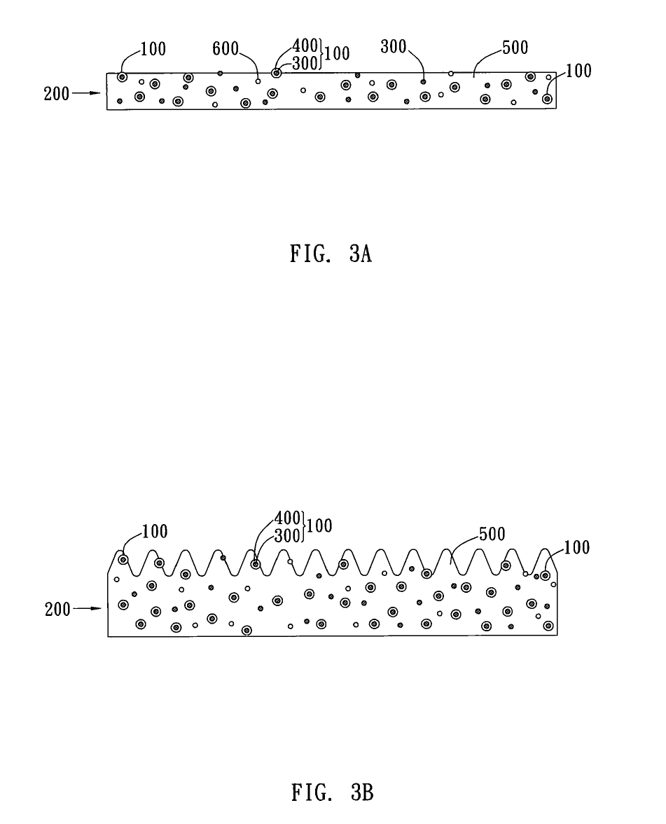

In another embodiment shown in FIG. 3A, the anti-glare film 200 of the present invention further includes at least a hollow particle 600 and at least a core particle 300. The hollow particle 600 can be one type of the multiple-coating particles embodiments. In the embodiment, the materials of the hollow particle 600 and the core particle 300 are selected from the group consisting of polystyrene, polymethylmethacrylate (PMMA), melamine, silicon oxide and a combination thereof. The hollow particle 600 is formed by encapsulating air therein using the above-identified materials. The hollow particle contains at least an outer layer. Because a refractive index difference exists between the material and air, the hollow particle 600 can scatter and refract light so as to provide anti-glaring effect. In another embodiment shown in FIG. 3B, the surface of the transparent resin 500 can be a convex-concave structure. Besides, certain multiple-coating particles 100, core particles 300, and hollow particles 600 may protrude out of the convex-concave surface of the transparent resin 500. Furthermore, in the embodiments shown in FIG. 3A and FIG. 3B, the anti-glare film 200 can be coated on a substrate having different shapes.

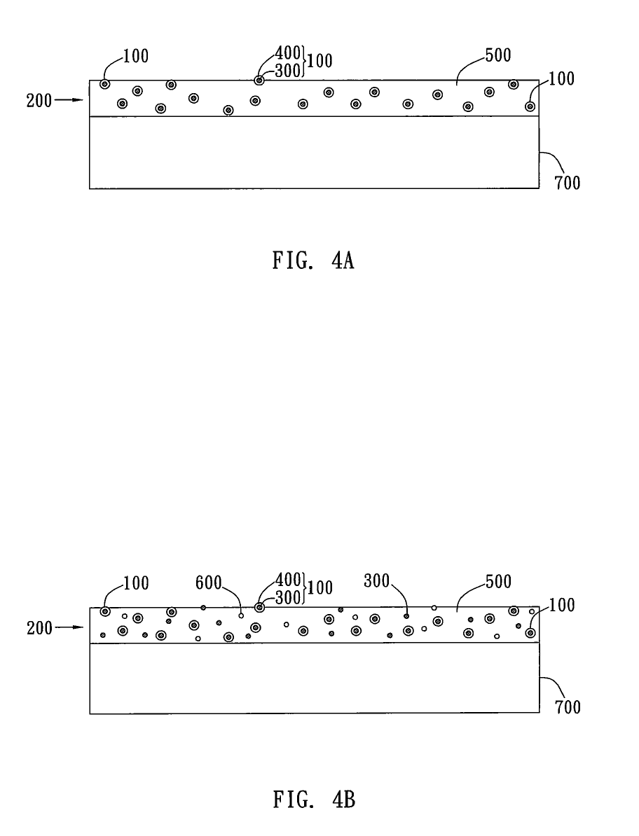

In the embodiments shown in FIG. 4A and FIG. 4B, the anti-glare film 200 is coated on a transparent substrate 700. The transparent substrate 700 is selected from the group consisting of cellulose triacetate, polyethylene terephthalate, cellulose diacetylene, cellulose acetate-butyrate, polyethersulfone, polymethyl methacrylate, polystyrene, polyacrylate, polyurethane resin, polyester, polycarbonate, polysulfone, polyether, polymethylpentene, polyether ketone, and a combination thereof. In this embodiment, the thickness of the transparent substrate 700 is between 10 μm and 500 μm, preferably, between 25 μm and 300 μm. In this embodiment, the transparent substrate 700 is a flat plate; however, in another embodiment, the anti-glare film 200 can be applied to substrates having different shapes such a sphere, a wave, a concave, and so on.

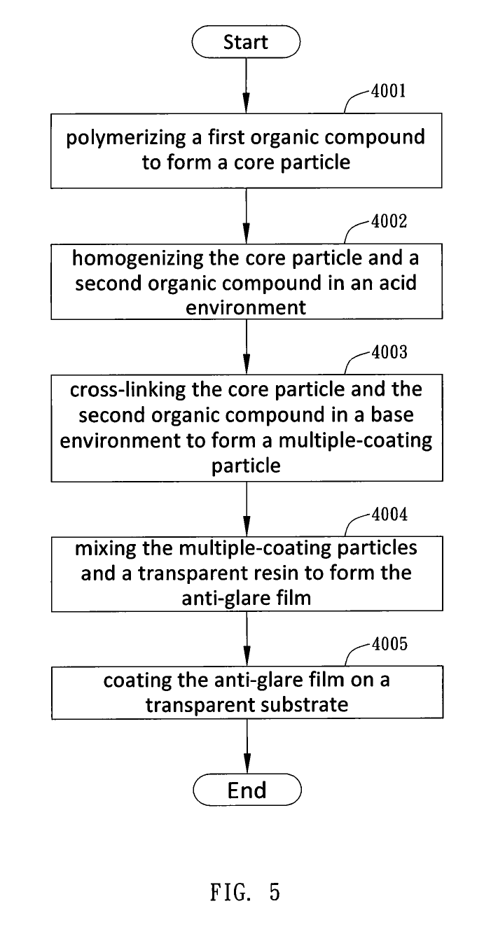

In a process figure shown in FIG. 5, a manufacture method for the anti-glare film includes: step 4001, polymerizing a first organic compound to form a core particle, wherein the first organic compound includes at least a double bond; step 4002, homogenizing the core particle and a second organic compound in an acid environment; step 4003, cross-linking the core particle and the second organic compound in a base environment to allow the second organic compound to cover the core particle to form a multiple-coating particle; step 4004, mixing the multiple-coating particles and a transparent resin to form the anti-glare film; and step 4005, coating the anti-glare film on a transparent substrate. The cross-linking process step 4003 further includes a method selected from the group consisting of sol-gel polymerization method, emulsion polymerization method, dispersion polymerization method, solution polymerization method, and a combination thereof. In coating step 4005, the multiple-coating particles are fixed in the transparent resin. In this case, after the coating step 4005, the transparent substrate and the anti-glare film are disposed in a circular oven at a temperature between 70° C. and 90° C. for about 1 to 10 mins. Then, the anti-glare film is polymerized by UV curing; however, in another embodiment, the anti-glare film can be self-cross linked after the coating step 4005 without additional drying processes and cross linking processes.

Nevertheless, in another embodiment, the mixing step 4004 further includes mixing the multiple-coating particles, the core particles, and the hollow particles.

In a first modified embodiment (FME), the manufacture method for the anti-glare film can mix the above-identified multiple-coating particles (whose diameter is preferably between 1 μm and 2 μm) and the UV curable transparent resin to form an anti-glare solution at a ratio of 1:100. Then, the anti-glare solution is coated on a cellulose triacetate plate (its preferred thickness is between 30 μm and 90 μm). Finally, the plate created with the anti-glare solution is placed in the circular oven at a temperature between 70° C. and 90° C. for about 1 to 10 mins. And then, UV-cured (540 mJ/cm² ) to polymerize and form the anti-glare film.

In a second modified embodiment (SME), the mixing step can further mix at least two kinds of multiple-coating particles (their respective diameter can be between 1 μm and 2 μm and 100 nm and 300 nm) and the transparent resin to form an anti-glare solution. Then, the anti-glare solution is coated on the cellulose triacetate plate (its preferred thickness is between 30 μm and 90 μm). Through the oven drying and the UV-curing processes described above, the anti-glare film is completed.

TABLE 1
test results of the anti-glare films of different embodiments

| | transmittance (%) | total haze (%) | Inner haze (%) | gloss(%) 60° |
|---|---|---|---|---|
| FME | 90.80 | 9.18 | 3.85 | 50.10 |
| SME | 90.15 | 23.97 | 5.78 | 31.90 |

Regarding Table 1, the transmittances of the first modified embodiment (FME) and the second modified embodiment (SME) are over 89%. Both of the total hazes are between 9.18% and 23.97%. Besides, both of the inner hazes are larger than 3%. Additionally, both the anti-glare films provide anti-glaring effect.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A multiple-coating particle for an anti-glare film, the multiple-coating particle comprising:
a core particle of a first organic compound; and
an outer layer of a second organic compound coated on the core particle to form the multiple-coating particle;
wherein the multiple-coating particle has a diameter between 50 nm and 10 μm and a refractive index between 1.45 and 1.62.

2. The multiple-coating particle of claim 1, wherein the first organic compound has a branch including at least a double bond.

3. The multiple-coating particle of claim 1, wherein the first organic compound is selected from the group consisting of polystyrene, polymethylmethacrylate (PMMA), melamine, silicon oxide, and a combination thereof.

4. The multiple-coating particle of claim 3, wherein silicon oxide has a structure: R¹ₙSi(OR²)₄₋ₙ, R¹ group is an alkyl group the same with or different from R² group, R¹ group and R² group are among C₁˜C₁₂ alkyl group, and n is 1 or 2.

5. The multiple-coating particle of claim 1, wherein the second organic compound is selected from the group consisting of polystyrene, polymethylmethacrylate (PMMA), melamine, silicon oxide, and a combination thereof.

6. The multiple-coating particle of claim 5, wherein silicon oxide has a structure: R¹ₙSi(OR²)₄₋ₙ, R¹ group is an alkyl group the same with or different from R² group, R¹ group and R² group are among C₁˜C₁₂ alkyl group, and n is 1 or 2.

7. The multiple-coating particle of claim 1, wherein a refractive index difference between the second organic compound and the first organic compound is between 0.05 and 0.17.

8. The multiple-coating particle of claim 1, wherein the multiple-coating particle includes a capsular particle.

9. An anti-glare film, comprising:
a transparent resin; and
a plurality of multiple-coating particles distributed in the transparent resin, wherein the multiple-coating particles have diameters between 50 nm and 10 μm and refractive indexes between 1.45 and 1.62, and each multiple-coating particles is comprised of:
a core particle of a first organic compound, wherein the first organic compound includes at least a double bond; and
a second organic compound coated on the core particle.

10. The anti-glare film of claim 9, wherein a refractive index difference between the second organic compound and the first organic compound is between 0.05 and 0.17.

11. The anti-glare film of claim 9, wherein a refractive index difference between the multiple-coating particle and the transparent resin is between 0.01 and 0.15.

12. The anti-glare film of claim 9, wherein a weight ratio of the multiple-coating particle to the transparent resin is between 1 % and 15%.

13. The anti-glare film of claim 9, wherein the transparent resin is cured by an effect selected from the group consisting of ultraviolet ray, infrared ray, visible light, thermo effect, pressure, radiation, or a combination thereof.

14. The anti-glare film of claim 9, wherein a material of the transparent resin is selected from the group consisting of polyester resin, polyether resin, acrylic acid resin, epoxy resin, urethane resin, alkyd resin, spiro acetal resin, polythiol polyolefin resin, polybutadiene resin, and a combination thereof.

15. The anti-glare film of claim 9, wherein the anti-glare film is used for coating on a transparent substrate.

16. The anti-glare film of claim 15, wherein a material of the transparent substrate is selected from the group consisting of cellulose triacetate, polyethylene terephthalate, cellulose diacetylene, cellulose acetate-butyrate, polyethersulfone, polymethyl methacrylate, polystyrene, polyacrylate, polyurethane resin, polyester, polycarbonate, polysulfone, polyether, polymethylpentene, polyether ketone, and a combination thereof.

17. The anti-glare film of claim 15, wherein a thickness of the transparent substrate is between 25 μm and 300 μm.

18. The anti-glare film of claim 9, wherein the first organic compound is selected from the group consisting of polystyrene, polymethylmethacrylate (PMMA), melamine, silicon oxide, and a combination thereof.

19. The anti-glare film of claim 18, wherein silicon oxide has a structure: R¹ₙSi(OR²)₄₋ₙ, R¹ group is an alkyl group the same with or different from R² group, R¹ group and R² group are among C₁˜C₁₂ alkyl group, and n is 1 or 2.

20. The anti-glare film of claim 9, wherein the second organic compound is selected from the group consisting of polystyrene, polymethylmethacrylate (PMMA), melamine, silicon oxide, and a combination thereof.

21. The anti-glare film of claim 20, wherein silicon oxide has a structure: R¹ₙSi(OR²)₄₋ₙ, R¹ group is an alkyl group the same with or different from R² group, R¹ group and R² group are among C₁˜C₁₂ alkyl group, and n is 1 or 2.

22. A manufacture process for an anti-glare film, comprising:
polymerizing a first organic compound including at least a double bond to form a core particle;
homogenizing the core particle and a second organic compound in an acid environment;
cross-linking the core particle and the second organic compound in a base environment to coat the second organic compound on the core particle to form a multiple-coating particle;
mixing the multiple-coating particle and a transparent resin to form the anti-glare film; and
coating the anti-glare film on a transparent substrate.

23. The manufacture method of claim 22, wherein the cross-linking step further includes a method selected from the group consisting of sol-gel polymerization method, emulsion polymerization method, dispersion polymerization method, solution polymerization method, and a combination thereof.
